(19) United States
(12) Patent Application Publication
(10) Pub. No.: US 2025/0125378 A1
(43) Pub. Date: Apr. 17, 2025

(54) Flexible Dryer Control and Optimization for Battery Electrode Manufacturing

(71) Applicant: Honeywell International Inc., Charlotte, NC (US)

(72) Inventors: Michael Forbes, North Vancouver (CA); Michael Hughes, North Vancouver (CA)

(21) Appl. No.: 18/381,007

(22) Filed: Oct. 17, 2023

(51) Int. Cl. H01M 4/88; H01M 4/04

(52) U.S. Cl. CPC H01M 4/8882; H01M 4/0404; H01M 4/0409

(57) ABSTRACT

System for control and optimization of a coated secondary battery electrode drying process includes a closed-loop process control module that is configured to process manufacturing data derived from a sheet production apparatus for coating a metal sheet with electrode material. The electrode production system includes: a continuous source of a sheet of metal substrate; a coater that is configured to apply electrode material to form a coated moving sheet; an oven that equipped with a heat source to remove solvent from the coat to form a dried coated moving sheet; means for determining the residual solvent content in the dried coated moving sheet and generating representative signals; and controller means for controlling the intensity of the heat source in response to the signals to maintain the residual solvent content at a desired level.

### FIELD OF THE INVENTION

The invention generally relates to manufacturing electrochemical batteries and more particularly to control, assessment and optimization techniques to improve the quality, throughput, and safety of secondary batteries such as lithium-ion cells in the electrode manufacturing process.

### BACKGROUND OF THE INVENTION

A lithium-ion cell is one type of secondary battery and contains four main parts: a positive electrode (a cathode), a negative electrode (an anode), a separator that is placed between the electrodes to prevent contact and shorting, and an electrolyte. Examples of a cathode active material may include but are not limited to: mixed-metal oxides, metal phosphates, or related materials. Examples of anode materials may include but are not limited to: graphite, silicon, or composites thereof. The electrolyte provides transport of the ions, and may be a liquid, solid, or liquefied gas. Battery manufacture begins with the fabrication of large sheets of double-side coated anode copper substrates and double-side coated cathode aluminum substrates. The electrodes are manufactured on a continuous roll-to-roll process where pre-mixed anode or cathode material is coated onto a sheet of metal substrate, which functions as a current collector. The coated sheet undergoes a drying process whereby solvent is removed to produce electrode sheets that are slit into appropriately-sized double-side coated metal substrates.

To achieve and maintain the quality of continuous, roll-to-roll production of electrodes, there must be constant, online measurements of quality factors that are strongly linked to battery performance. Control of the dryer operation currently relies on periodic inspection and lab evaluation of the dried electrode to determine if the coating is over-dried or under-dried. Drying defects can adversely affect battery performance. Drying at high rates can disturb the uniform distribution of binder and affects electrode durability. Surface cracking can occur if thick coatings are dried too quickly. Over-drying occurs when too much solvent is removed from the coating causing it to become brittle. Under-drying leaves excess solvent in the coating which in turn increases the time required for vacuum drying, reducing plant level throughput.

### SUMMARY OF THE INVENTION

The present invention is based, in part, on the development of a method for dynamic performance assessment and control of the secondary battery cell electrode fabrication employing residual solvent control in the drying of coated battery electrodes. The residual solvent in the electrode coating(s) at the dryer exit(s) are regulated to some solvent level target(s) by adjustment of the heating apparatuses employed in the dryer stage(s). Depending on the available measurements, actuators, and known process parameters, the details and sophistication of the strategy can change while maintaining the overall goal of minimizing residual solvent deviation from target. This gives a flexible dryer control and optimization method. This dryer control strategy allows flexibility to accommodate both direct online solvent measurements and periodic lab-based measurements, and also other ‘soft-sensor’ measurements such as estimates based on other available data. This method reduces time, capital expenditures, operational expenditures, and increases throughput and quality of the battery cells.

The general electrode dryer control strategy, for instance, can use control strategies such as proportional-integral-derivative (PID), deadtime compensated PID, internal model control, Dahlin control, or model predictive control to adjust the dryer air flows and/or temperatures of the dryer air flows to regulate the solvent measurement to a target.

In one aspect, the invention is directed to a system for control and optimization of a coated secondary battery electrode drying process that employs a closed-loop process control module that is configured to process manufacturing data derived from a sheet production apparatus for coating a metal sheet with electrode material. The process manufacturing data include in-line process parameter, such as, for example: (a) coating slurry flow rate; (b) coating slurry density; (c) temperature of drying gas in a drying oven; (d) flow rate of drying gas in a drying oven; (e) surface temperature of the sheet inside a drying oven; (f) residual solvent level in dried electrode material exiting a drying oven; and (g) speed of moving coated metal sheet through a drying oven.

In another aspect, the invention is directed to an electrode production system that includes:
a continuous source of a sheet of metal substrate which moves in a machine direction (MD);
a first coater that is configured to apply a first coat of first electrode material onto a first surface of the moving metal substrate to form a first coated moving sheet;
a first oven that is downstream of the first coater and wherein a first heat source that is in communication with the first oven heats the first coated moving sheet to remove solvent from the first coat to form a dried first coated moving sheet;
means for determining the first residual solvent content in the dried first coated moving sheet and generating first signals representing the first residual solvent content; and
first controller means for controlling the intensity of the first heat source in response to the first signals to maintain the first residual solvent content at a first desired level.

In a further aspect, the invention is directed to a method of preparing electrodes which includes:
(i) providing a sheet of metal substrate which moves in a machine direction (MD);
(ii) applying one or two coatings of electrode material onto the sheet of metal substrate to form a single or double-side coated moving sheet of metal substrate having one or two coated layers;
(iii) providing a first heat source which heats the coated moving sheet to remove solvent from the one or two coated layers to form a dried coated moving sheet;
(iv) determining the residual solvent level in the one or two coated layers of the dried coated moving sheet; and
(v) regulating the intensity of the first heat source to maintain the residual solvent level in the one or two coated layers at desired target levels.

Heat sources employed preferably include convective hot air sources or infrared heating devices. Depending on the actuators available and in the case of convective hot air heating, for example, control of the process could entail: adjusting the hot air flow rate(s), without adjusting the temperature(s) of the hot air flows; adjusting the temperature(s) of the hot air flow(s) without adjusting the hot air flow rate(s); or adjusting both the flow rate(s) and temperature(s) of the hot air flow(s). In cases where there is more than one dryer stage, a strategy will be needed to determine the relative changes for the air flow(s) and temperature(s). For example, if the flow(s) are controlled, it may be advantageous to set a bias between flows so that if there are 2 stages, the flow to the second stage is always a set amount different than the flow to the first stage.

### BRIEF DESCRIPTION OF THE DRAWINGS

FIG. 1 shows an electrode manufacturing dryer control system that employs residual solvent calculated from mass balance;

FIG. 2 shows an electrode manufacturing dryer control system that employs residual solvent measurements of the dried coated electrode and solvent level measurements in the dryers;

FIG. 3 shows an electrode manufacturing dryer control system that produces a double-side coated electrode wherein both sides are dried simultaneously;

FIG. 4 a roll-to-roll sheet production system for continuous coating of a metal substrate with anodic or cathodic materials to produce a double-side coated electrode wherein the coated sides are dried sequentially; and

FIG. 5 shows a block diagram for a system for optimizing electrode manufacturing.

### DETAILED DESCRIPTION OF PREFERRED EMBODIMENTS

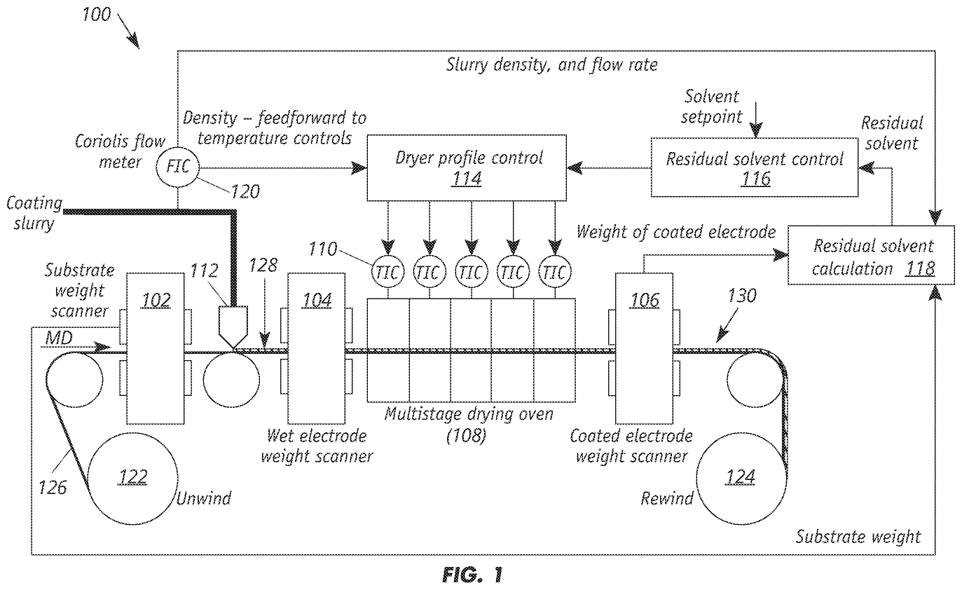

As shown in FIG. 1, a dryer control system 100 regulates the production of electrodes for secondary batteries whereby a roll is unwound by an unwinder 122 and supplies a continuous metal web or sheet 126 whose basis weight (weight per unit area) and/or thickness is measured by beta scanner 102. (The dimensions and basis weight of the metal sheet are often known.) Coater 112 applies a layer of electrode slurry on the top surface to form coated metal sheet 128. The coater 112, such as a slot die coater, includes actuators that control a slot die/doctor blade to regulate the amount of slurry that is extruded. The slurry is composed of anodic or cathodic active material particles, conductive additives, polymer binder, and solvent. For making anodes, the electrode coating includes anodic active materials such as graphite and, for making cathodes, the electrode coating includes cathodic active materials such as a lithium metal oxide. Electrodes include a current collector metal foil that is coated on both sides of the foil with electrode slurry which can also include carbon black, binder, and solvent. After the electrode slurry is applied on a side of foil, the wet coated foil is heated in a dryer to extract the solvent to leave a solid layer of electrode material which adheres to the metal foil. Copper foil is a preferred anode current collector material and aluminum foil is a preferred cathode current collector material.

A tachometer (not shown) measures the speed of the metal sheet as it moves in the machine direction (MD). The mass flow rate of the coating slurry is regulated with a flow indicator controller 120 which can comprise a Coriolis flow meter. Beta scanner 104 measures the basis weight (or areal weight) of the wet electrode layer on the coated metal sheet 128 which then enters into a multistage drying oven 108. Each stage is supplied with heated gas such as air at a specific temperature and flow rate. Temperature indicator controllers (TIC) 110 regulate the temperature inside each stage by adjusting the heated gas flow rate or temperature. Beta scanner 106 measures the basis weight of the dried coated electrode sheet 130 exiting the oven 108 before being taken up by a rewinder 124 to form a roll. The heated air which circulates into and exits out of each stage of the multistage drying oven 108 removes excess solvent and cures the electrode slurry on the moving coated sheet 128 to form a dried electrode layer that is attached to the metal sheet. The temperature and/or flow rate of the gas in each stage can be regulated to provide optimized drying so that the dried coated electrode 130 meets the residual solvent target level. In one embodiment, the temperature and/or flow rate in the first stage that the wet coated electrode sheet 128 encounters can be the highest so that there is a temperature and/or flow rate gradient along the length of oven 108. While the present invention is described herein using heating gas (air), it is understood that other heating schemes such as the use of infrared heating elements can be employed.

Beta scanner 106 measurements provide the total basis weight of the dried coated electrode 130. This total basis weight includes the weight of the substrate (thin metal foil) and the weight of the coating, which includes the coating solids and any residual solvent. Subtracting the basis weight of the substrate from the total basis weight yields the areal weight of the coating of the dried electrode 130. In the dryer control system 100, the wet coat weight is directly measured by the scanning sensor 104 located just downstream of the coater 112.

Given that the coating weight=total basis weight−substrate. Then if the weight of the coating solids that is applied to a metal sheet is known or determined, the weight of residual solvent that remains in the coating exiting oven 108 can be calculated by subtracting the coating solids weight from the coating weight, that is: solvent weight=coating weight−coating solids weight.

It is often preferred to state the solvent weight as a percentage of the coating weight: residual solvent [%]=100×solvent weight/coating weight.

While solvent evaporates from the coated metal sheet 128 in dryer oven 108, there is no loss of coating solids from the coating layer and therefore the areal weight of the coating solids in the dried coated electrode 130 exiting the dryer oven must be equal to the areal weight of the coating solids that was applied by coater 112 to the moving metal sheet 126. The mass flow rate of the slurry being pumped to the coater 112 can be measured. The width of the coated area on the foil substrate is known and the speed at which the foil substrate moving past the coater is measured. The (areal) weight of wet coating applied to the metal foil sheet 126 is: wet coat weight=mass flow rate of slurry/(sheet width×machine speed).

Alternatively, wet coat weight can be directly measured by scanning sensor 104 located just downstream of the coater 112.

In cases where the composition of the slurry is known, the composition itself and component material properties thereof can be used to calculate the coating solids weight. As stated above, the slurry is composed of electrode active material particles, conductive additives, polymer binder, and solvent. If the solvent is added to the coating solids to achieve a fixed solvent mass fraction, then the coating solids mass fraction relationships are:

solvent mass fraction=mass of solvent/(mass of solvent+mass of coating solids) and coating solids mass fraction=1−solvent mass fraction.

Then the areal weight of the coating solids that is applied at the coater 112 is expressed as: coating solids weight=(coating solids mass fraction)×(wet coat weight).

Alternatively, measurements of the composition and component material properties of the electrode slurry can be employed to calculate the coating solids weight. As stated above, the slurry includes active material particles, conductive additives, polymer binder, and solvent. If the solvent is added to the coating solids to achieve a fixed known solvent mass fraction, then the coating solids mass fraction is readily derived. Given that solvent mass fraction=mass solvent/(mass solvent+mass coating solids), it follows that the coating solids mass fraction=1−solvent mass fraction. The areal weight of the coating solids that are applied by coater 112 is expressed as: coating solids weight=coating solids mass fraction×wet coat weight.

Finally, the coating solids mass fraction, and therefore the amount of residual solvent, can be calculated from the density of the electrode slurry when the weight of solvent or mass ratio of solvent added to the electrode slurry is unknown. The density of the coating slurry can be measured by the Coriolis flow meter 120 that is placed on the slurry piping located upstream of the coater 112. The Coriolis flow meter provides an accurate mass flow rate of the slurry as well as the density of the coating slurry as it is extruded onto the metal sheet 126. Because the densities of the coating solids components and mass fractions within the coating solids are known, the overall density of the coating solids can be calculated. Following the definition of density (mass/volume) and using the available measurements and parameters, in the absence of a known slurry solvent mass fraction, the coating solids mass fraction can be derived from the following relationships:
(a) Total slurry density=(mass coating solids+mass solvent)/(volume coating solids+volume solvent); and
(b) Total slurry density=(mass coating solids+mass solvent)/(mass coating solids/density coating solids+mass solvent/density solvent).

Dividing the right-hand side top and bottom of (b) by total mass, yields:
(c) Total slurry density=1/((coating solids mass fraction/density coating solids)+(solvent mass fraction/density solvent)). Since the mass fractions must equal 1:
(d) mass fraction coating solids+mass fraction solvent=1, and therefore:
(e) Total slurry density=1/((mass fraction coating solids/density coating solids)+((1−mass fraction coating solids)/density solvent)). And rearranging (e) yields:
(f) mass fraction coating solids=(1/total slurry density−1/density solvent)/(1/density coating solids−1/density solvent). From relationship (f), one can determine the coating solids weight and therefore the solvent weight in the coating at the exit to the dryer 108 in FIG. 1.

Another method of obtaining the slurry density is to calculate from wet coating weight and wet coating thickness measurements using the relationship:
(g) slurry density=wet coating density=wet coat weight/wet coat thickness.

Using one of the above-described methods enables the coating solids weight to be determined, which allows the residual solvent in the coating after the dryer to be calculated.

The dryer control system 100 includes a dryer profile control 114, residual solvent control 116 and residual solvent calculation unit 118. In one application as illustrated in FIG. 1, the residual solvent calculation unit receives: (a) coating slurry density signals from the Coriolis flow mater, (b) signals from substrate weight scanner 102 that are representative of the basis weight of the moving metal or substrate 130, and (c) signals from the coated electrode weight scanner that are representative of the weight of coated electrode on the dried coated electrode 130. The solvent calculation unit 118 continuously determines the residual solvent in the moving dried coated electrode 130 from the data and transmits the calculations to residual solvent control 116, which is a PID or another conventional controller. The dryer profile control 114 receives: (a) coating slurry density signals from the Coriolis flow meter and (b) signals from the residual solvent control 116 to generates control signals that regulate the temperature of the gas that is fed into each of the stages of multistage drying oven 108 in order to achieve the desired solvent residual setpoint.

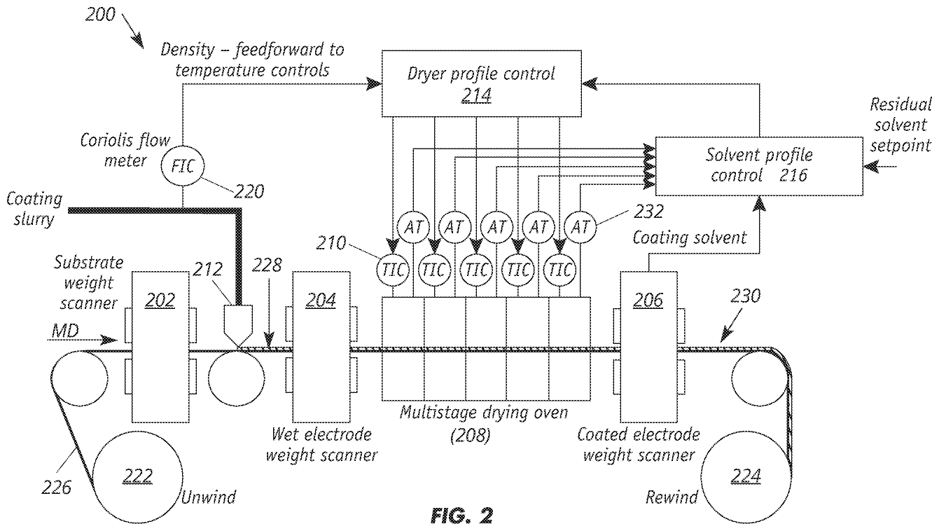

FIG. 2 illustrates a dryer control system 200 for electrode manufacturing that employs solvent measurements in the drying oven and residual solvent measurements in the dried coated electrode. A roll is unwound by an unwinder 222 and supplies a continuous metal web or sheet 226 whose basis weight (weight per unit area) and/or thickness is measured by beta scanner 202. Coater 212 applies a layer of electrode slurry on the top surface to form coated metal sheet 228 which moves in the machine direction (MD).

The mass flow rate of the coating slurry is measured with flow indicator controller 220 which includes a Coriolis flow meter. Beta scanner 204 measures the basis weight (or areal weight) of the wet coat weight of the electrode on the coated metal sheet 228 just downstream of coater 212 and before it enters into a multistage drying oven 208.

Each stage of the oven is supplied with heated gas at a specific temperature and flow rate. Temperature indicator controllers 210 regulate the temperature inside each stage by adjusting the heated gas flow rate or temperature. An analysis transmitter (AT) provides a measurement of solvent levels in the electrode coating to solvent profile controller 216. Beta scanner 206 measures the basis weight of the dried coated electrode sheet 230 exiting the dryer 208 before being taken up by a rewinder 224 to form a roll. The multistage drying oven 208 removes excess solvent and cures the electrode slurry on the moving coated sheet 228 to form an electrode layer on the dried electrode 230.

Beta scanner 206 measures the basis weight of the dried coated electrode. This total basis weight includes the weight of the substrate (thin metal foil) and the weight of the coating, which includes the coating solids and any residual solvent. Subtracting the basis weight of the substrate 226 from the total basis weight of the dried coated electrode 230 yields the areal weight of the coating on the dried electrode 230.

The coating solvent levels of the dried coated electrode 230 are derived from the measurements from coated electrode weight scanner 206. The residual solvent profile control 216 receives: (a) signals representative of the coating solvent levels, and (b) signals from analysis transmitters 232 representative of the solvent levels in each of the five stages in multistage drying oven 208. The dryer profile control 214 receives: (a) coating slurry density signals from the Coriolis flow meter and (b) signals from the residual solvent control 216 to generate control signals that regulate the temperature in each of the stages of multistage drying oven 208 in order to achieve the desired solvent residual setpoint.

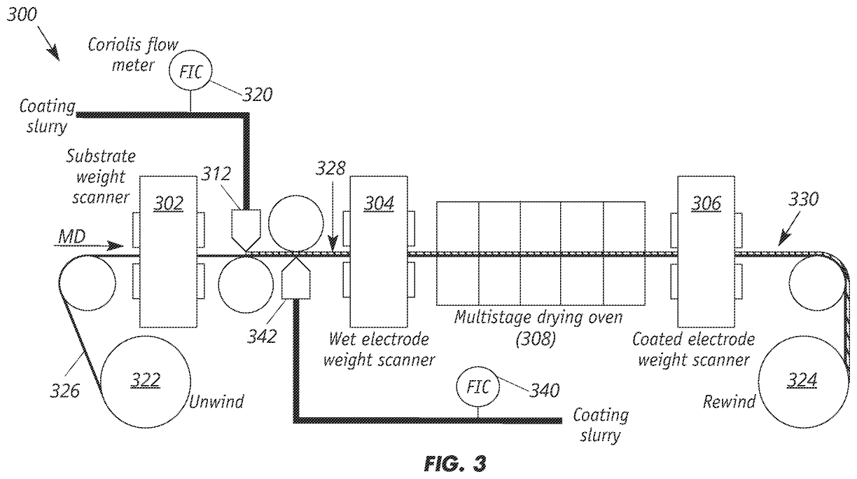

FIG. 3 illustrates an electrode production system 300 for manufacturing doubled-sided electrodes wherein both coated sides are dried at the same time. A substrate roll is unwound by an unwinder 322 and supplies a continuous metal web or sheet 326 whose basis weight and/or thickness is measured by beta scanner 302. Coaters 312 and 342 apply a top layer and a bottom layer of electrode slurry, respectively, on the top and lower surface to form doubled-side coated metal sheet 328 which moves in the machine direction (MD).

The mass flow rates of the top coating slurry and bottom coating slurry are measured with flow indicator controller 320 and 340, respectively. Beta scanner 304 measures the basis weight (or areal weight) of the two wet coat weights of the electrode on the coated metal sheet 328 before it enters into a multistage drying oven 308.

Each stage of the oven is supplied with heated gas at a specific temperature and flow rate. Beta scanner 306 measures the basis weight of the dried coated electrode sheet 330 exiting the dryer 308 before being taken up by a rewinder 324 to form a roll. The multistage drying oven 308 removes excess solvent and cures the electrode slurry on the moving coated sheet 328 to form a double-sided electrode on the dried electrode 330. Beta scanner 306 measurements the basis weight of the dried coated electrode.

In a preferred application, the residual solvent in each side of the electrode is measured independently as described previously. In facilities where direct online residual solvent measurement is not available, the residual solvent levels can be estimated. From scanned weight measurements by scanner 306 at the exit of the dryer oven 308, the total weight of the electrode 230 is known. The total weight of electrode 230 includes the weight of the substrate as well as the weight of the coating on each side of the substrate, each of which includes the coating solids and any residual solvent. As in the above, subtracting the weight of the foil substrate yields the combined weight of the two coating layers: total coating weight=coating weight side 1+coating weight side 2=total basis weight−substrate weight.

Applying the same methods as described above, the coating solids weight for each side of the electrode can be obtained. With these values, the total residual solvent left in the electrode at the exit to the dryer is:

solvent weight=total coating weight−coating solids weight side 1−coating solids weight side 2.

Preferably, the amount of solvent remaining in each of the two coatings would be known allowing the opportunity to independently control residual solvent in each side of the coating. Additional modeling is required to specify how to estimate the amount of solvent in each coating side. For example, models include: (a) assuming that 50% of the total residual solvent is in each side of the coating; and (b) assuming the solvent is split between each side of the coating in proportion to the coating solids weights of each side of the coating.

With the residual solvent for each side of the electrode either measured or estimated, independent control of the solvent in each side can be executed depending on the details of the dryer stages of multistage dryer oven 308. If there is independent control of the air flows to each side of the electrode in the dryer stages, then the flows and temperatures applied to each side of the electrode can be independently adjusted to control the residual solvent for that side of the electrode. In cases where there is not independent control, then there will be some trade-off between the control for each side. For example, a weighted total error of the residual solvent could be controlled, where: weighted total error=side 1 weight×(residual solvent side 1 target−residual solvent side 1)+side 2 weight×(residual solvent side 2 target−residual solvent side 2).

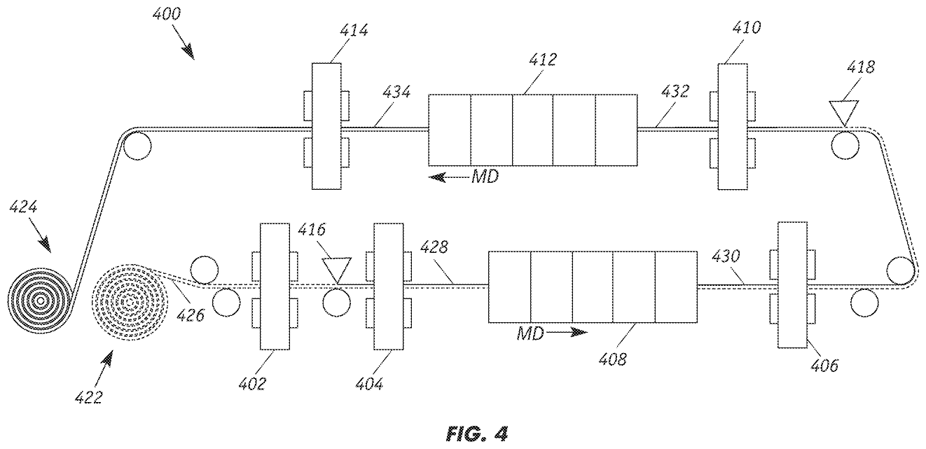

FIG. 4 illustrates a sheet production system 400 for continuous coating of a metal substrate with electrode materials to fabricate a double-sided coated electrode wherein the coated sides are dried in sequence. In this continuous process, a roll 422 supplies a continuous metal web or sheet 426 that is coated on a top surface with a layer of electrode slurry by a coater 416. The basis weight, thickness, and other characteristics of the metal web or sheet 426 are usually known; scanning beta gauges 402 and 404 are employed to measure, respectively, the basis weight and/or thickness before, and after, the electrode slurry is applied by the coater 416.

The coater 416 applies slurry onto the sheet 426. A first multistage dryer oven 408 removes excess solvents and cures the slurry that is on a moving coated sheet 428 to form an electrode layer on the sheet. A scanning beta gauge 406 measures the basis weight and/or thickness of the moving dried coated sheet 430 exiting the dryer oven 408. Thereafter, rolling supports reverse the orientation of a moving sheet 430 so that the uncoated side is on top whereupon a coater 418 applies a layer of electrode slurry on the top uncoated surface. The basis weight and/or thickness of a double-side coated sheet 432 are then measured with a scanning beta gauge 410 before entering a second multistage dryer oven 412. Further downstream, a beta scanner measures the basis weight and/or thickness and the temperature of the double-coated sheet 434. A rewinder takes up the double-side coated sheet into roll 424.

The residual solvent control for coated slurry on first side of the moving coated sheet 428 in the first multistage dryer oven 408 can be performed as described above. For control of the residual solvent in the coating on the second side at the second multistage dryer oven 412, requires additional assumptions and modeling. In the absence of direct online residual solvent measurements, an estimate of residual solvent level can be made following similar principles to above. The coating solids weight for the second side can be calculated as above using the coating composition, coating slurry mass flow to the second coater, the width of the coating on the foil, and the machine speed. If the solvent fraction of the slurry is unknown, a second Coriolis flow meter is needed to measure the slurry density at the second coater.

Similar to the case of drying a substrate that is coated on both sides with slurry at once, a scanning weight sensor 414 at the dryer oven 412 exit would measure the total weight of the electrode. Knowing the coating solids weights for both sides, the total residual solvent in the electrode at the exit to the second dryer can be calculated: solvent weight=total coating weight−coating solids weight side 1−coating solids weight side 2.

The difference in this case is that the first side was already dried to some level at the entrance to the second dryer oven 412. Within the second dryer oven 412, as well as the second coated side drying, the first side will continue to dry. To determine how much of the total residual solvent remains in each side of the electrode, it could be assumed that 50% of the total residual solvent is in each side of the coating or that the solvent is split between each side of the coating in proportion to the coating solids weights of each side of the coating. However, neither of these models account for the fact that the second side of the coating will start with a much higher fraction of residual solvent than the first side. One model that accounts for one side starting out drier than the other side is to assume that the rate of evaporation is in proportion to amount of solvent.

Applying this model assigns the residual solvent to each side of the sheet as follows:
(a) final solvent ratio side 1=solvent in side 1 at dryer entry/(total solvent in both sides at dryer entry) and
(b) final solvent ratio side 2=solvent in side 2 at dryer entry/(total solvent in both sides at dryer entry).
And (c) solvent weight side 1 (at dryer exit)=final solvent ratio side 1×solvent weight and
(d) solvent weight side 2 (at dryer exit)=final solvent ratio side 2×solvent weight.

The solvent in the first side of the sheet at the second dryer entry can be taken as the solvent in the first side of the sheet at the exit of the first dryer (assuming a negligible amount of drying takes place between dryer ovens).

The solvent in the second side of the sheet at the second dryer oven 412 entry can be obtained in the same way that the coating solids on the second side of the sheet was determined. Since the mass fraction coating solids is already determined, the solvent fraction can be obtained from mass fraction solvent in side 2 at second dryer oven 412 entry=1−mass fraction coating solids. Moreover, since the wet coating weight has been determined, therefore the solvent in side 2 at the second dryer oven entry=mass fraction solvent in side 2 at dryer entry×wet coating weight. With these values, the solvent in each side of the sheet can be determined according to model that states that evaporation rate is proportional to amount of solvent in each side of the sheet. Finally, laboratory-based measurements could be used to develop an empirical model.

Where the electrode has both sides coated but the two sides are dried in sequence, it is necessary to avoid over-drying on the first coated side. By closing the loop on residual solvent in the coating at the exit of the first dryer oven, the setpoint for the residual solvent level can be adjusted to minimize over-drying in the second dryer oven by raising the target residual solvent level at the exit to the first dryer oven subject to first coated side of the electrode being dry enough to withstand the handling required for the second side to be coated and for the electrode to reach the second dryer oven. By reducing the amount of drying of the first coated side in the first drying oven, the amount of drying that both electrode sides receive will be more balanced. This should reduce the “two-sidedness” phenomenon where the coating properties are different on each side of the sheet.

There are numerous ways to implement this strategy. One example implementation is to find a target setpoint for the residual solvent from the first drying oven to minimize overall defects, where: overall defects=defects due to handling under-dried first coated side+defects due to drying of first coated side+defects due to drying of second coated side.

Defects due to handling under-dried first coated side will be a function of the residual solvent target for the first dryer oven exit. This can be 0% for residual solvent levels below some threshold low value (which can be experimentally obtained) and 100% above some threshold high value (which can be experimentally obtained); and the function can ramp linearly from 0 to 100 over the range from the low threshold value to the high threshold value. Other functional forms can be used, and the model can be adjusted as more data becomes available.

Defects due to drying of the first and second coated sides should each take some functional form that has a global minimum at the ideal dryness value which results in the least amounts of defects; the function should be non-decreasing to either side of the minimum. For example, there could be a high threshold (which can be experimentally obtained) above which the function takes the value 100%. The function could ramp from the global minimum the high threshold. There could be a low threshold value (which can be experimentally obtained) below which the function takes some high value reflective of high defects due to over-drying. The function could ramp from the global minimum to the low threshold. Other functional forms can be used, and the model can be adjusted as more data becomes available.

To complete this model, it is necessary to relate the final dryness of the first and second sides of the electrode to the residual moisture setpoint for the first coating at the exit to the first dryer oven. As described above, one method is to relate the dryness at the exit of the first dryer oven to the dryness at the exit of the second dryer oven. For the purposes of optimizing the amount of drying between first and second drying ovens, this method could be used assuming that the actual dryness at the exit to the first dryer oven will be kept at setpoint. This is just one example of how an optimization strategy can be built on top of the closed-loop residual solvent controls.

As discussed above, the inventive closed-loop residual solvent controller(s) can adjust the available dryer actuators (air flows and/or temperatures of the air flows) in order to regulate the residual solvent to the chosen setpoint(s). A means of determining the relative amount of adjustment to each final control element is needed, and one technique is biasing one actuator to another. However, more sophisticated options are available. For example, an estimated drying factor could be created for each dryer stage by multiplying the air flow and the temperature of the air flow. Drying factor=air flow×air temperature. Then, the residual solvent controller could be configured to control the residual solvent by adjusting a target for the total of the drying factors.

There could then be a drying distribution controller designed to distribute the total drying among the drying stages. This controller could make this distribution optimally accounting for drying rates and drying costs. The cost of drying in each stage can be determined by putting a price on the resources needed to provide the hot air. The drying rates could, for example, be proportional to the drying factors. An objective to optimize the distribution of the drying factors could then be: Drying objective=sum of costs of drying at each stage+weighting factor×sum of differences between drying rates between the stages in multistage drying oven. This objective can then be minimized over the drying rates for each dryer stage. Such an objective would balance minimizing drying costs with the need to keep a uniform rate of drying across the dryer stages.

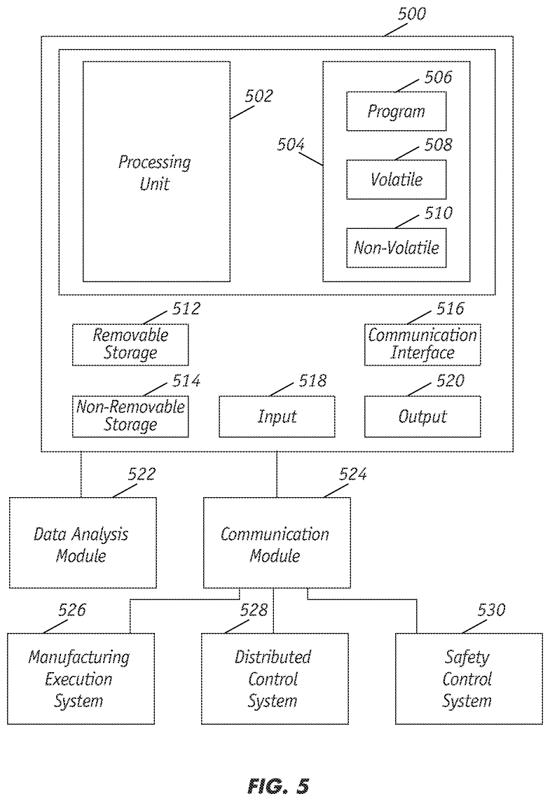

FIG. 5 shows a control module 500 which regulates the functions of the manufacturing lines of the present invention. As used herein, the term “module” refers to any means for facilitating communications and/or interaction between the elements of the manufacturing line and performing additional processes, tasks and/or functions to support operation of the manufacturing line, as described herein. In various embodiments, the control module 500 may be any hardware, software, firmware, electronic control component, processing logic, and/or processor device, individually or in any combination. Depending on the embodiment, the control module 500 may be implemented or realized with a general purpose processor (shared, dedicated, or group) controller, microprocessor, or microcontroller, and memory that executes one or more software or firmware programs; a content addressable memory; a digital signal processor; an application specific integrated circuit (ASIC), a field programmable gate array (FPGA), any suitable programmable logic device; combinational logic circuit including discrete gates or transistor logic; discrete hardware components and memory devices; and/or any combination thereof, designed to perform the functions described herein.

The control module can comprise a computer system that includes a processing unit 502, a memory 504, a removable storage 512, and a non-removable storage 514. Although the example computing device is illustrated and described as the computer system, the computing device may be in different forms in different embodiments. For example, the computing device may instead be a smartphone, a tablet, a smartwatch, or other computing devices. Devices such as smartphones, tablets, and smartwatches are generally collectively referred to as mobile devices. Furthermore, although the various data storage elements are illustrated as part of the control module 500, the storage may also, or alternatively, include cloud-based storage accessible via a network, such as the Internet.

The memory 504 may include a volatile memory 508 and a non-volatile memory 510. The computer system may include—or have access to a computing environment that includes—a variety of computer-readable media, such as the volatile memory 508 and the non-volatile memory 510, the removable storage 512 and the non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices capable of storing computer-readable instructions for execution to perform functions described herein.

The computer system may include, or have access to, a computing environment that includes an input 518, an output 520, and a communication interface 516. The output 520 may include a display device, such as a touchscreen, that also may serve as an input device. The input 518 may include one or more of a touchscreen, touchpad, mouse, keyboard, camera, one or more device-specific buttons, one or more sensors integrated within, or coupled via, wired or wireless data connections to the control module 500, and other input devices 518. The computer system may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable storage device are executable by the processing unit 502. A hard drive, CD-ROM, and RAM are some examples of articles including a non-transitory computer-readable medium such as a storage device. The terms computer-readable medium and storage device do not include carrier waves. For example, a computer program 306 may be used to cause the processing unit 502 to perform one or more methods of the present invention.

Although a single control module can control entire manufacturing lines, it is understood that the individual stations of the manufacturing line can be equipped with a control module to specifically monitor and regulate the devices associated with the particular station. For instance, a data analysis module 522 is employed to receive and process in-line data for analysis and visualization. A communication module 524 is employed to transmit performance assessment metrics and adjust process parameters to a manufacturing execution system (MES) 526 or a distributed control system (DCS) 528 which can be located in remote servers. The MES or DCS in turn can direct the automated storage and retrieval systems and/or autonomous mobile robots to maneuver metal substrate rolls or finished products. The MES or DCS can be incorporated into computer system such as a “Centralized Operations Console” or “Integrated Operations Center,” or equivalent, wherein data can be displayed in a human-machine interface (HMI). The communication module 524 can transmit in-line process information acquired from ovens to a safety control system 530, which is an early electrode failure detection mechanism. For instance, it can provide early smoke or battery off gas and/or heat detection, thermal imaging, electrolyte vapor detection, and related safety measures that prevent thermal runaway.

The foregoing has described the principles, preferred embodiment and modes of operation of the present invention. However, the invention should not be construed as limited to the particular embodiments discussed. Instead, the above-described embodiments should be regarded as illustrative rather than restrictive, and it should be appreciated that variations may be made in those embodiments by workers skilled in the art without departing from the scope of present invention as defined by the following claims.

What is claimed is:

1. A system for control and optimization of a coated secondary battery electrode drying process that comprises a closed-loop process control module that is configured to process manufacturing data derived from a sheet production apparatus for coating a metal sheet with electrode material.

2. The system of claim 1 wherein the process manufacturing data is one or more in-line process parameter that is selected from the group consisting of (a) coating slurry flow rate; (b) coating slurry density; (c) temperature of drying gas in a drying oven; (d) flow rate of drying gas in a drying oven; (e) surface temperature of the sheet inside a drying oven; (f) residual solvent level in dried electrode material exiting a drying oven; and (g) speed of moving coated metal sheet through a drying oven.

3. The system of claim 2 wherein the closed-loop process control module is configured to compare real-time in-line process parameters against a set of selected process parameter values and to direct the sheet production apparatus to execute protocols to bring the residual solvent level in the dried electrode material exiting the drying oven closer to desired target values.

4. The system of claim 1 wherein the sheet production apparatus comprises a coater that is configured to apply a coat of electrode material onto the moving sheet of metal substrate to form a coated moving sheet of metal substrate that is dried in an oven to remove excess solvent from the electrode material.

5. The system of claim 4 wherein the closed-loop process control module is configured to:
receive and analyze manufacturing data;
determine deviations from desired target values, and
based on deviations which are determined, direct the sheet production apparatus to either execute, terminate or implement alternate heating procedures.

6. The system of claim 1 wherein the closed-loop control module is operatively connected to a data analysis module that is configured to receive and process manufacturing data for analysis and wherein the data analysis module comprises a processor which is configured to perform data processing and analysis using algorithms and extract performance assessment metrics.

7. The system of claim 1 wherein the sheet production apparatus comprises: (a) a first coater that is configured to apply a first coat of a first electrode material onto a first surface of the moving sheet of metal substrate; (b) a second coater that is configured to apply a second coat of a second electrode material onto a second surface of the moving sheet of metal substrate to form a double-side coated moving sheet of metal substrate which is dried in an oven to simultaneously remove excess solvent from the first electrode material and the second electrode material.

8. The system of claim 1 wherein the sheet production apparatus comprises: (a) a first coater that is configured to apply a first coat of a first electrode material onto a first surface the moving sheet of metal substrate to form a first coated moving sheet of metal substrate which is dried in a first oven to form a dried first coated moving sheet of metal substrate that has been dried to a selected target; (b) a second coater that is configured to apply a second coat of a second electrode material onto a second surface of the dried first coated moving sheet of metal substrate to form a double-sided coated moving sheet of metal substrate which is dried in a second oven to remove excess solvent from the first electrode material and the second electrode material.

9. An electrode production system that comprises:
a continuous source of a sheet of metal substrate which moves in a machine direction (MD);
a first coater that is configured to apply a first coat of first electrode material onto a first surface of the moving metal substrate to form a first coated moving sheet;
a first oven that is downstream of the first coater and wherein a first heat source that is in communication with the first oven heats the first coated moving sheet to remove solvent from the first coat to form a dried first coated moving sheet;
means for determining the first residual solvent content in the dried first coated moving sheet and generating first signals representing the first residual solvent content; and
first controller means for controlling the intensity of the first heat source in response to the first signals to maintain the first residual solvent content at a first desired level.

10. The electrode production system of claim 9 wherein (i) the first heat source comprises a source of first gas flow, wherein the first controller means controls the temperature and/or flow of heated gas from the source of first gas flow in response to the first signals or (ii) the first heat source comprises a first infrared heating element, wherein the first controller controls the heat output from the first infrared heating element in response to the first signals.

11. The electrode production system of claim 9 that comprises:
a second coater that is configured to apply a second coat of second electrode material onto a second surface of the first coated moving sheet to form a double-sided coated moving sheet;
a second oven that is downstream of the second coater and wherein a second heat source that is in communication with the second oven heats the double-sided coated moving sheet and to remove solvent from the first coat and second coat to form a dried double-side coated moving sheet;
means for determining the second residual solvent content in first coat on the dried double-sided coated moving sheet and generating second signals representing the second residual solvent content;
means for determining the third residual solvent content in the second coat on the dried double-sided coated moving sheet and generating third signals representing the third residual solvent content; and
second controller means for controlling the intensity of the second heat source in response to the second signals and third signals to maintain the second residual solvent content at a second desired level and the third residual solvent content at a third desired level.

12. The electrode production system of claim 11 wherein (i) the second heat source comprises a source of second gas flow, wherein the second controller means controls the temperature and/or flow of heated gas from the source of second gas flow in response to the second signals and third signals or (ii) the second heat source comprises a second infrared heating element, wherein the second controller means controls the heat output from the second signals and third signals.

13. The electrode production system of 11 that comprises:
a continuous source of a sheet of metal substrate which moves in a machine direction (MD);
a second coater that is configured to apply a second coat of second electrode material onto a second surface of the moving metal substrate to form a double-sided coated moving sheet;
wherein the first oven is downstream of the second coater and wherein the first heat source that is in communication with the first oven heats the double-sided coated moving sheet to remove solvent from the first coat and the second coat to form a dried first coated moving sheet;
means for determining the second residual solvent content in the second coat of the dried first coated moving sheet and generating second signals representing the second residual solvent content; and
control means for controlling the intensity of the first heat source in response to the second signals to maintain the second residual solvent content at a second desired level.

14. A method of preparing electrodes which comprises:
(i) providing a sheet of metal substrate which moves in a machine direction (MD);
(ii) applying one or two coatings of electrode material onto the sheet of metal substrate to form a single or double-side coated moving sheet of metal substrate having one or two coated layers;
(iii) providing a first heat source which heats the coated moving sheet to remove solvent from the one or two coated layers to form a dried coated moving sheet;
(iv) determining the residual solvent level in the one or two coated layers of the dried coated moving sheet; and
(v) regulating the intensity of the first heat source to maintain the residual solvent level in the one or two coated layers at desired target levels.

15. The method of claim 14 wherein (i) the first heat source comprises a first heated gas that flows pass the coated moving sheet and step (v) comprises regulating the temperature and/or flow rate of the first heated gas or (ii) the first heat source comprises a first infrared heating element that transfers heat to the coated moving sheet and step (v) comprises regulating the heat output of the first infrared heating element.

16. The method of claim 14 wherein step (ii) comprises forming a double-sided coated moving sheet with electrode material on an upper side of the metal substrate and on a lower side of the metal substrate.

17. The method of claim 14 wherein
step (ii) comprises forming a single-sided coated moving sheet by applying a first electrode material onto the sheet of metal substrate to form a first layer of first electrode material;
step (iii) comprises exposing the single-sided coated moving sheet to a first heat source in a first oven to form the dried coated moving sheet;
step (iv) comprises determining the intensity of the first heat source in the first layer on the dried coated moving sheet; and
step (v) comprises regulating the intensity of the first heat source in the first oven to maintain the residual solvent level in the first layer on the dried coated moving sheet at desired target levels; and said method further comprising:
(vi) applying a coating of a second electrode material onto the dried coated moving sheet to form a double-sided coated moving sheet of metal substrate having a first layer of the first electrode material and a second layer of the second electrode material;
(vii) providing a second heat source to the double-sided coated moving sheet to remove solvent from the first coated layer and the second coated layer to form a dried double-side coated moving sheet;
(viii) determining the residual solvent levels in the first coated layer and the second coated layer of the dried double-side coated moving sheet; and
(ix) regulating the intensity of the second heat source to maintain the residual solvent levels in the first coated layer and the second coated layer at desired target levels.

18. The method of claim 17 wherein (i) the first heat source comprises a first heated gas and step (v) regulates the temperature and/or flow rate of the first heated gas or (ii) the first heat source comprises a first infrared heating element and step (v) regulates the heat output of the first infrared heating element.

19. The method of claim 17 wherein (i) the second heat source comprises a second heated gas and step (ix) regulates the temperature and/or flow rate of the second heated gas or (ii) the second heat source comprises a second infrared heating element and step (ix) regulates the heat output of the second infrared heating element.
